(19) United States
(12) Patent Application Publication
(10) Pub. No.: US 2017/0346239 A1
(43) Pub. Date: Nov. 30, 2017

(54) ELECTRICAL CONNECTOR

(71) Applicant: Lotes Co., Ltd, Keelung (TW)

(72) Inventors: Ted Ju, Keelung (TW); Wu Feng, Keelung (TW); Ya Jun Zeng, Keelung (TW); Nan Fang He, Keelung (TW); Jun Fan, Keelung (TW); Jin Ke Hu, Keelung (TW); Guo Sheng Zhou, Keelung (TW); Chin Chi Lin, Keelung (TW)

(21) Appl. No.: 15/679,439

(22) Filed: Aug. 17, 2017

Related U.S. Application Data
(63) Continuation of application No. 15/263,413, filed on Sep. 13, 2016.
Application No. 15/263,413 is a continuation of application No. 14/626,709, filed on Feb. 19, 2015.
(60) Provisional application No. 62/024,728, filed on Jul. 15, 2014.
(60) Provisional application No. 61/942,830, filed on Feb. 21, 2014.

(51) Int. Cl. H01R 13/6585; H01R 13/6581; H01R 13/6594; H01R 13/6583; H01R 13/6591; H01R 24/60; H01R 107/00; H01R 12/72

(52) U.S. Cl. CPC H01R 13/6585; H01R 13/6591; H01R 13/6581; H01R 24/60; H01R 13/6594; H01R 13/6583; H01R 12/724; H01R 2107/00

(57) ABSTRACT

An electrical connector includes an insulation body. Multiple terminals are arranged in the insulation body in two rows. Each terminal in the lower row has a first retaining portion, a first extending portion bending downward from the first retaining portion, and a first contact portion extending forward from the first retaining portion. A second extending portion is connected to the first extending portion. A middle grounding plate is disposed in the insulation body, having a body portion and a plate portion. The body portion has a first section connected to the plate portion and located above and parallel to the second extending portion, and a second section extending forward from the first section. The plate portion is located at and parallel to the first extending portion. A distance between the first section and the second extending portion is greater than that between the plate portion and the first extending portion.

### CROSS-REFERENCE TO RELATED APPLICATION

This application is a continuation application of U.S. application Ser. No. 15/263,413, filed Sep. 13, 2016, which is a continuation application of U.S. application Ser. No. 14/626,709, filed Feb. 19, 2015, which itself claims priority to and the benefit of, pursuant to 35 U.S.C. §119(e), U.S. provisional patent application Ser. No. 61/942,830, filed Feb. 21, 2014, and U.S. provisional patent application Ser. No. 62/024,728, filed Jul. 15, 2014. The entire contents of the above identified applications are incorporated herein by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to an electrical connector, and more particularly to an electrical connector having a good shielding effect.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Chinese Patent CN201320378153.0 discloses, in paragraph [0008] of the specification, an electrical connector, which includes an insulation body, a first terminal group retained to the insulation body and a shielding member. The insulation body includes a base and a tongue extending forward. The tongue has a first surface and a second surface disposed opposite to each other. The first terminal group is exposed to the first surface, and the shielding member is disposed at the tongue and located between the first surface and the second surface. The first terminal group includes a grounding terminal. The grounding terminal is provided with a contact portion protruding towards the shielding member and contacting the shielding member. Paragraph [0020] discloses that the shielding member is integrally formed at a mating plate, the first terminal group and the second terminal group are oppositely assembled to the mating plate and then assembled forward to an assembly frame along with the mating plate, forming the insulation body. However, when the electrical connector of such a structure is used for transmitting high-speed signals, electromagnetic radiation produced by the first terminal group and the second terminal group is easy to leak backward, resulting in that crosstalk is produced during signal transmission at tails of the first terminal group and the second terminal group, which affects signal transmission quality of the electrical connector. In addition, terminals of such an electrical connector are simultaneously assembled to the first surface and the second surface, and as there are more terminals and the tongue is smaller, operations are inconvenient, which easily results in that the terminals are not mounted firmly and tilt upward, damaging the whole electrical connector.

Therefore, a heretofore unaddressed need exists in the art to address the aforementioned deficiencies and inadequacies.

### SUMMARY OF THE INVENTION

In one aspect, the present invention relates to an electrical connector of which upper and lower grounding plates can cover a base portion of an insulation body to increase coverage of an inner metal shell and achieve a good shielding effect.

In certain embodiments, an electrical connector includes an insulation body, multiple terminals, an inner metal shell, and an outer metal shell. The insulation body has a base and a tongue located in a front end of the base. The multiple terminals are fixedly arranged in the base in upper and lower rows. Each of the upper row of terminals has a contact portion exposed to an upper surface, and each of the lower row of terminals has a contact portion exposed to a lower surface of the tongue. The inner metal shell has at least one covering portion disposed on the upper surface of the tongue, and at least one extending portion extending from the covering portion to the base, and the extending portion covers the base. The outer metal shell wraps the inner metal shell externally.

In one embodiment, the extending portion has at least one contacting arm, and the contacting arm urges against an inner wall of the outer metal shell.

In one embodiment, the end of the contacting arm bends downward to form a positioning portion, the base is provided with a concave slot corresponding to the positioning portion, and the positioning portion is received in the concave slot.

In one embodiment, a first receiving space is depressed from the base, and the extending portion is accommodated in the first receiving space.

In one embodiment, the inner metal shell further has a connection portion for vertically connecting the covering portion and the extending portion.

In one embodiment, the inner metal shell includes an upper grounding plate and a lower grounding plate, the upper grounding plate covers the upper surface of the tongue, and the lower grounding plate adjoins the lower surface of the tongue.

In one embodiment, each of two sides of the tongue is provided with a reserving slot, each of two side walls of the upper grounding plate is provided with a mating portion, each of two side walls of the lower grounding plate is provided with a fixing portion corresponding to the mating portion, and the mating portions and the fixing portions are accommodated in the reserving slot in a mutually mating manner to enable the inner metal shell to wrap a rear end of the tongue.

In one embodiment, the lower grounding plate has a stopping portion, and the stopping portion adjoins a lower surface of the base.

In one embodiment, the upper row of terminals and the lower row of terminals respectively include at least two grounding terminals. The grounding terminals are located at edges of the tongue and are each provided with a protruding portion in a front end thereof. The protruding portions partially protrude beyond the edges of the tongue.

In one embodiment, the upper row terminal and the lower row terminal are symmetrically arranged on the tongue, each terminal in the upper row terminal has a first rear portion disposed in the base, each terminal in the lower row terminal has a second rear portion disposed in the base, and the first rear portion and the second rear portion are arranged in two rows.

In one embodiment, the electrical connector further includes a middle grounding plate. The middle grounding plate includes a flat plate portion retained in the tongue and located between the upper row terminal and the lower row terminal, and a vertical portion extending downward from a rear end of the flat plate portion, and the vertical portion is located between the first rear portion and the second rear portion.

In one embodiment, a snap-fit slot depressed inward is formed on each of the two sides of the tongue, and the flat plate portion is partially exposed to the snap-fit slot.

In one embodiment, the tongue is assembled on the base, a lower surface of the base has a second receiving space, the insulation body further includes a plastic block, and the plastic block is accommodated in the second receiving space and assembled on the base.

Another aspect of the present invention relates to an electrical connector, which includes: an insulation body; a plurality of terminals, arranged in the insulation body in an upper row and a lower row, each of the terminals in the lower row having a first retaining portion, a first extending portion bending downward from a rear side of the first retaining portion, and a first contact portion extending forward from the first retaining portion, wherein the first retaining portion comprises a second extending portion connected to the first extending portion; and a middle grounding plate, disposed in the insulation body and located between the terminals in the upper low and the lower row, wherein the middle grounding plate has a body portion and a plate portion bending downward from a rear side of the body portion, the body portion has a first section connected to the plate portion and a second section extending forward from the first section, the first section is located above the second extending portion and is parallel to the second extending portion, the plate portion is located at a rear side of the first extending portion and is parallel to the first extending portion, and a distance between the first section and the second extending portion is greater than a distance between the plate portion and the first extending portion.

In one embodiment, the plate portion is perpendicular to the body portion.

In one embodiment, the insulation body comprises a base and a tongue located at a front end of the base, the first contact portion is exposed from a lower surface of the tongue, the first retaining portion stretches across the base and the tongue, the first extending portion and the first section are respectively located in the base, and the second section is located in the tongue.

In one embodiment, the first contact portion is parallel to the second section, and a distance between the first contact portion and the second section is shorter than the distance between the first section and the second extending portion.

In one embodiment, the first retaining portion has a third extending portion connected to the first contact portion, and the third extending portion is located in the tongue.

In one embodiment, the third extending portion is parallel to the second section, and a distance between the third extending portion and the second section is equal to a distance between the first contact portion and the second section.

In one embodiment, the first retaining portion comprises a fourth extending portion connecting to the second extending portion and the third extending portion, and the fourth extending portion is located in the base.

In one embodiment, the fourth extending portion is gradually close to the first section from rear to front.

In one embodiment, a length of a projection of the fourth extending portion in a front-rear direction is shorter than a length of a projection of the first extending portion in the front-rear direction.

In one embodiment, a length of a projection of the fourth extending portion in a vertical direction is shorter than a length of the second extending portion.

In one embodiment, the insulation body shields a lower grounding plate, and the lower grounding plate has a first shielding portion located on the lower surface of the tongue, a second shielding portion located on a bottom surface of the base, and a third shielding portion connected to the first shielding portion and the second shielding portion.

In one embodiment, the fourth extending portion is gradually away from the second shielding portion from rear to front.

In one embodiment, the second shielding portion is parallel to the second extending portion, the first shielding portion is parallel to the third extending portion, and a distance between the second shielding portion and the second extending portion is greater than a distance between the first shielding portion and the third extending portion.

In one embodiment, the second shielding portion is located in front of the first extending portion.

In one embodiment, each of the terminals in the upper row has a second retaining portion, a second contact portion extending forward from the second retaining portion, and a fifth extending portion bending downward from a rear end of the second retaining portion, the second contact portion is exposed from an upper surface of the tongue, the second retaining portion stretches across the base and the tongue, and the fifth extending portion is located in the base.

In one embodiment, the fifth extending portion is located at a rear side of the plate portion and is parallel to the plate portion.

In one embodiment, a distance between the fifth extending portion and the plate portion is equal to the distance between the first extending portion and the plate portion.

In one embodiment, a lower end of the fifth extending portion horizontally extends backward to form a first soldering portion, and a projection of a lower end edge of the plate portion in a front-rear direction is higher than a projection of the first soldering portion in the front-rear direction.

In one embodiment, the first extending portion protrudes downward beyond a bottom surface of the base, and the first extending portion connects to a second soldering portion.

In one embodiment, the first extending portion and the second extending portion are connected through an arc-shaped bending portion.

The present invention has the following beneficial effects: in the electrical connector, the inner metal shell has the extending portion covering an upper surface of the base, which increases coverage of the inner metal shell, effectively improves signal transmission quality at the end of the terminals and improves signal transmission stability of the whole electrical connector. The insulation body is assembled by the base, the plastic block and the tongue, which simplifies the manufacturing process of the insulation body and reduces the manufacturing cost of the electrical connector. Moreover, the middle grounding plate is provided with a first hole. An edge of each of two lateral sides of the middle grounding plate is inwardly depressed to form a first groove. The first hole is located between the two first grooves, the insulation body has a first insulation post and a second insulation post, the first insulation post protrudes into the first hole, and the second insulation post protrudes into the first grooves. The first insulation post and the second insulation post can better secure the middle grounding plate, so that in a process that the electrical connector is plugged in a mating connector, the middle grounding plate can be stably retained between the upper and lower rows of terminals without displacement, thereby improving high-frequency performance of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic three-dimensional exploded view of an electrical connector according to one embodiment of the present invention.

FIG. 2 is a schematic partial three-dimensional exploded view of an electrical connector according to one embodiment of the present invention.

FIG. 3 is a schematic three-dimensional assembly view of an electrical connector according to one embodiment of the present invention.

FIG. 4 is a sectional view of the electrical connector according to one embodiment of the present invention.

FIG. 5 is a schematic three-dimensional exploded view of a mating connector according to one embodiment of the present invention.

FIG. 6 is a schematic three-dimensional assembly view of a mating connector according to one embodiment of the present invention.

FIG. 7 is a sectional view when an electrical connector according to one embodiment of the present invention mates a mating connector.

FIG. 8 is a schematic three-dimensional exploded view of a second embodiment of an electrical connector according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” and/or “multiple” means two or more.

As used herein, the terms “comprising”, “including”, “carrying”, “having”, “containing”, “involving”, and the like are to be understood to be open-ended, i.e., to mean including but not limited to.

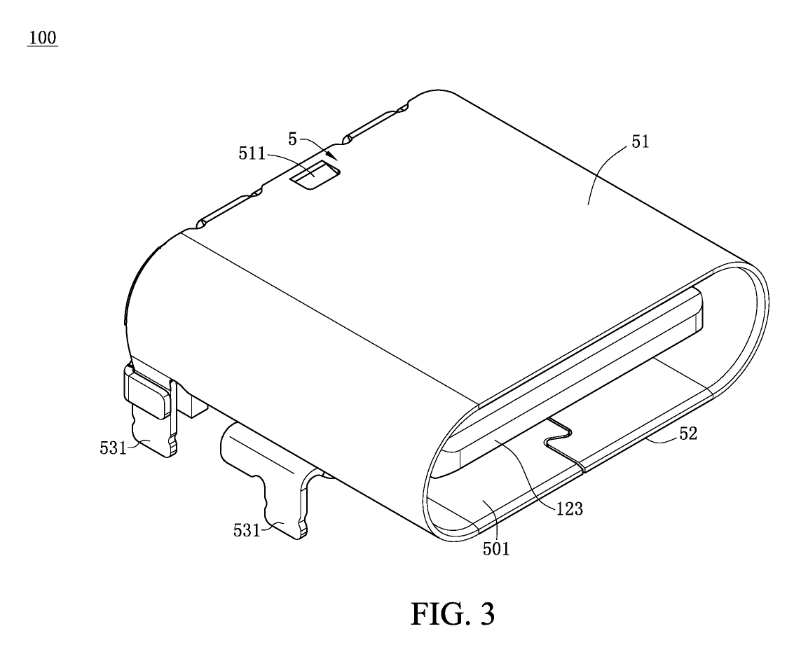

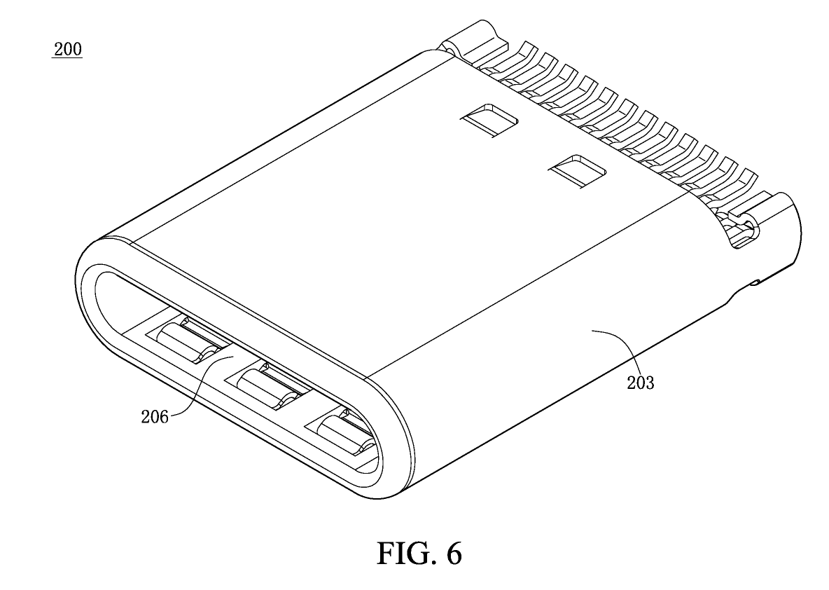

As shown in FIGS. 3 and 6, an electrical connector 100 according to certain embodiments of the present invention is an electrical connector socket that supports high-speed data transmission, and a mating connector 200 is an electrical connector plug that supports high-speed data transmission.

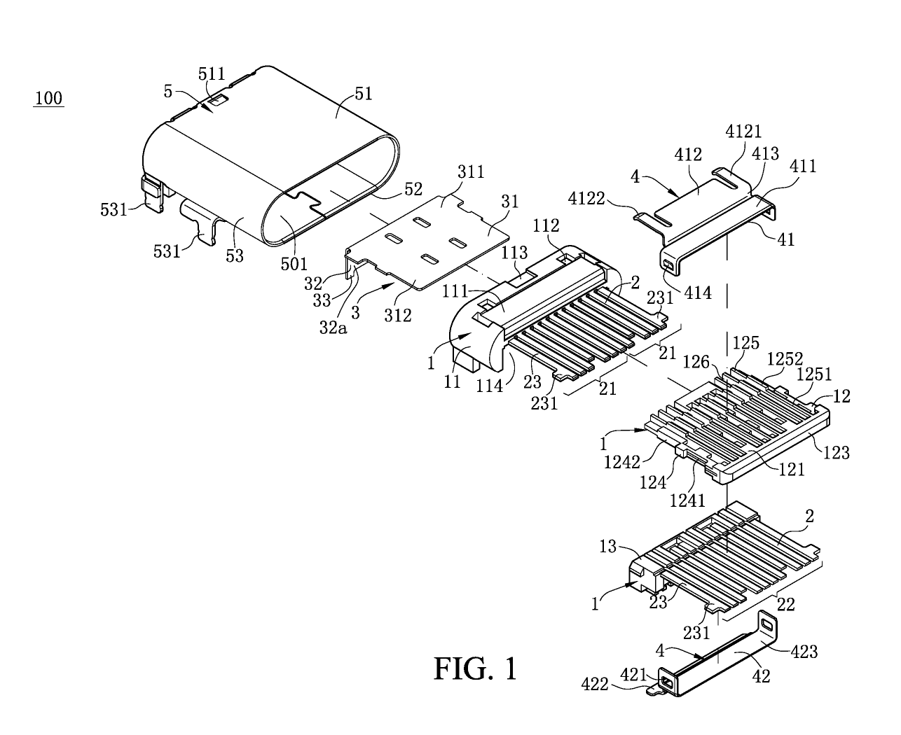

As shown in FIGS. 1-3, the electrical connector 100 includes an insulation body 1, multiple terminals 2 fixed disposed at the insulation body 1; a middle grounding plate 3 fixed disposed at the insulation body 1; an inner metal shell 4 covering and fixed onto the insulation body 1; and an outer metal shell 5 framed outside the insulation body 1 and the inner metal shell 4, to form an insertion space 501. The outer metal shell 5 has multiple soldering pins 531, and the soldering pins 531 can be correspondingly soldered onto a grounding circuit of a circuit board (not shown).

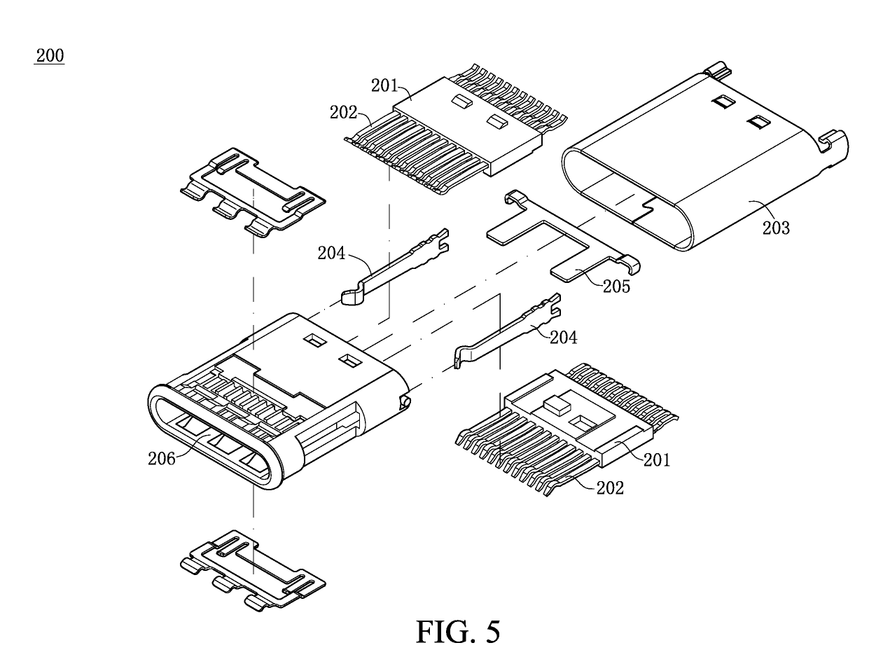

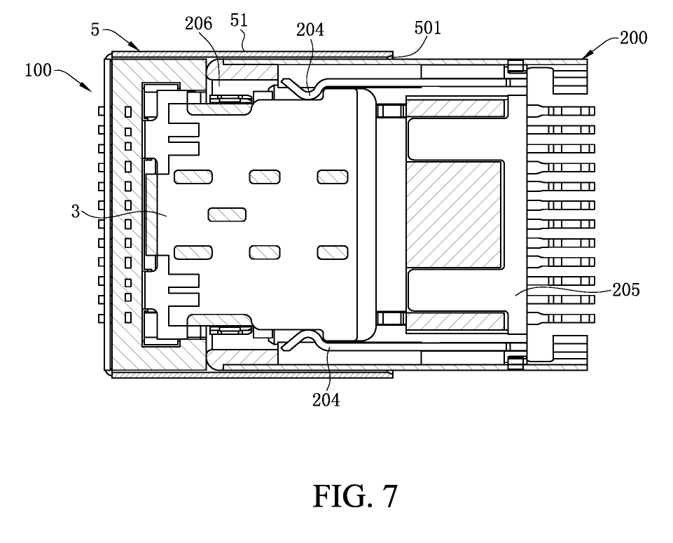

As shown in FIGS. 5-7, the mating connector 200 includes a plastic body 201, multiple contact terminals 202 fixed to the plastic body 201, a shielding casing 203 wraps the plastic body 201, a middle shielding sheet 205 fixedly disposed in the plastic body 201, two retaining elastic sheets 204 respectively fixedly disposed to two sides of the plastic body 201, and a mating cavity 206 disposed in a front end of the plastic body 201. When the mating connector 200 is inserted into the insertion space 501 of the electrical connector 100, in addition to that the contact terminals 202 are connected with the corresponding multiple terminals 2, the retaining elastic sheets 204 may contact the middle grounding plate 3 to form a first grounding shielding structure, thus preventing electromagnetic radiation from passing through the insulation body 1 to leak backward to interfere signal transmission of the terminals 2. Moreover, the outer metal shell 5 and the shielding casing 203 form a second grounding shielding structure, which can thus effectively form a wholly surrounded shielding structure.

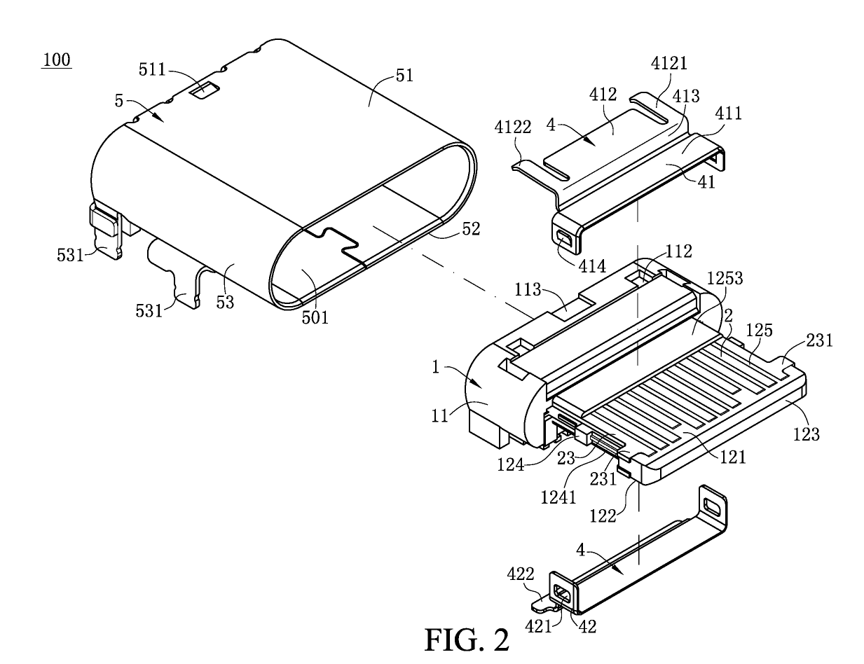

As shown in FIGS. 1 and 2, in an electrical connector according to a first embodiment of the present invention, the insulation body 1 includes a base 11 and a tongue 12 assembled to a front end of the base 11, and a plastic block 13 superimposed below the base 11. In other embodiments, the base 11, the tongue 12 and the plastic block 13 may be integrally formed or formed in any other manners, which is not limited herein.

As shown in FIGS. 1, 4 and 7, a first receiving space 111 is depressed from an upper surface of the base 11 along a vertical direction. Two concave slots 112 are depressed from a rear end of the first receiving space 111. In the vertical direction, the depth of the concave slots 112 is greater than that of the first receiving space 111. The upper surface of the base 11 is further provided with a limiting slot 113, and the limiting slot 113 is in communication with a rear end face of the base 11. A lower surface of the base 11 is provided with a second receiving space 114, and the plastic block 13 is assembled in the second receiving space 114. The tongue 12 has an upper surface 121 and a lower surface 122 opposite up and down, and a front surface 123 and two side surfaces 124 connected between the two surfaces. The upper surface 121 and the lower surface 122 are respectively provided with multiple barriers 125 to form multiple terminal receiving slots 126. The barriers 125 further include a front section 1251 and a rear section 1252, and a thickness dimension of the rear section 1252 is greater than that of the front section 1251, to facilitate that the rear section 1252 has a good hot-melting condition when the insulation body 1 is assembled. A snap-fit slot 1241 depressed inward is further formed in a front end of each of the two side surfaces 124. The snap-fit slots 1241 partially accommodate the retaining elastic sheets 204, to enable the retaining elastic sheets 204 to connect the middle grounding plate 3. A reserving slot 1242 is further formed at a rear end of each of the two side surfaces 1241, for reserving assembly space for the inner metal shell 4.

As shown in FIGS. 1, 2 and 4, the multiple terminals 2 include a group of upper row terminals 21 and a group of lower row terminals 22 exposed from an upper surface and a lower surface of the tongue 12 respectively. The upper row terminals 21 are integrally formed with the base 11. Each of the upper row terminals 21 includes a first mating portion 211, a first rear portion 212 and a first connection portion 213 connected between the first mating portion 211 and the first rear portion 212. The first mating portion 211 may extend backward to form the first connection portion 213, the first connection portion 213 may bend downward and extend to form the first rear portion 212 that is vertical, and the first rear portion 212 may bend backward and extend to form a first soldering portion 214 that is horizontal. The lower row terminals 22 are integrally formed with the plastic block 13. Each of the lower row terminals 22 includes a second mating portion 221, a second rear portion 222 and a second connection portion 223 connected between the second mating portion 221 and the second rear portion 222. The second mating portion 221 may extend backward to form the second connection portion 223, the second connection portion 223 may bend downward and extend to form the second rear portion 222 that is vertical, and the second rear portion 222 may bend forward and extend to form a second soldering portion 224 that is horizontal.

Each of the lower row terminals 22 includes a first retaining portion 223a, a first extending portion 222a bending downward from a rear side of the first retaining portion 223a, and a first contact portion 221a extending forward from the first retaining portion 223a. The first contact portion 221a is exposed from the lower surface of the tongue 12. The first contact portion 221a is the second mating portion 221. The first retaining portion 223a is the second connection portion 223. The first retaining portion 223a stretches across the base 11 and the tongue 12. The first retaining portion 223a includes a second extending portion 2231, which is connected to the first extending portion 222a. The first extending portion 222a is located in the base 11. The first retaining portion 223a includes a third extending portion 2233, which is connected to the first contact portion 221a. The third extending portion 2233 is located in the tongue 12. The first retaining portion 223a has a fourth extending portion 2232, which is connected to the second extending portion 2231 and the third extending portion 2233. The fourth extending portion 2232 is located in the base 11. Each of the upper row terminals 21 includes a second retaining portion 213a, a fifth extending portion 212a bending downward from a rear end of the second retaining portion 213a, and a second contact portion 211a extending forward from the second retaining portion 213a. The second contact portion 211a is exposed from the upper surface of the tongue 12. The second retaining portion 213a is the first connection portion 213. The second retaining portion 213a stretches across the base 11 and the tongue 12. The second contact portion 211a is the first mating portion 211.

The first extending portion 222a is the second rear portion 222. The fourth extending portion 2232 is located at a rear side of a front end face of the base 11. The first extending portion 222a is formed by vertically extending downward from a rear side of the second extending portion 2231. The second extending portion 2231 and the first extending portion 222a are connected through an arc-shaped connection portion. The second extending portion 2231 and the fourth extending portion 2232 are also connected through an arc-shaped bending portion. A length of a projection of the fourth extending portion 2232 in a front-rear direction is shorter than a length of a projection of the first extending portion 222a in the front-rear direction. A length of a projection of the fourth extending portion 2232 in a vertical direction is shorter than a length of the second extending portion 2231. The second extending portion 2231 and the first extending portion 222a are both provided in the base 11. The fifth extending portion 212a is located in the base 11 and is parallel to the first extending portion 222a. The fifth extending portion 212a is the first rear portion 212.

When the base 11, the tongue 12 and the plastic block 13 are assembled together, an upper surface of the rear section 1252 forms a flat plate portion 1253 through hot melting to retain the first connection portion 213, and a lower surface of the rear section 1252 forms the flat plate portion 1253 through hot melting to retain the second connection portion 223, preventing the terminals 2 from tilting upward in the terminal receiving slot 126. The first mating portion 211 is correspondingly received in the terminal receiving slot 126 and exposed to the upper surface 121. The second mating portion 221 is correspondingly received in the terminal receiving slot 126 and exposed to the lower surface 122. The first rear portions 212 and the second rear portions 222 are arranged in two rows. The upper row terminal 21 and the lower row terminal 22 further respectively include two grounding terminals 23. The grounding terminals 23 are located at edges of the tongue 12 and each has a protruding portion 231 in front ends thereof, and the protruding portions 231 partially protrude beyond the edges of the tongue 12, avoiding worn out of the tongue 12 during mating of the electrical connector 100. The first mating portions 211 and the second mating portions 221 are symmetrically disposed at 180 degrees in the inserting space 501, thus enabling the mating connector 200 to be inserted into the electrical connector 100 in dual orientation.

As shown in FIGS. 1, 4 and 7, the middle grounding plate 3 includes a body portion 31, a vertical portion 32, and multiple grounding pins 33. The body portion 31 is retained into the tongue 12 and located between the upper row terminal 21 and the lower row terminal 22, separates the upper row terminal 21 and the lower row terminal 22, and shields signal interference between the upper row terminal 21 and the lower row terminal 22. The body portion 31 is further partially exposed to the snap-fit slot 1241 and connected with the retaining elastic sheets 204. The vertical portion 32 extends downward from a rear end of the body portion 31, is located between the first rear portions 212 and the second rear portions 222, separates the first rear portions 212 and the second rear portions 222, and shields signal interference between the first rear portions 212 and the second rear portions 222. The vertical portion 32 is a plate portion 32a that vertically extends downward from the rear end of the body portion 31.

The body portion 31 has a first section 311 and a second section 312 horizontally extending forward from the first section 311. The first section 311 is located in the base 11, and the second section is located in the tongue 12. The first section 311 is parallel to the second extending portion 2231 and is located above the second extending portion 2231. The plate portion 32a is located at a rear side of the first extending portion 222a and is parallel to the first extending portion 222a. A distance between the first section 311 and the second extending portion 2231 is greater than a distance between the plate portion 32a and the first extending portion 222a.

A distance between the third extending portion 2233 and the second section 312 of the middle grounding plate 3 is shorter than a distance between the second extending portion 2231 and the first section 311 of the middle grounding plate 3. The fourth extending portion 2232 is gradually close to the first section 311 from rear to front. The fifth extending portion 212a of each upper row terminal 21 is located at a rear side of the plate portion 32a. A distance between the fifth extending portion 212a and the plate portion 32a of the middle grounding plate 3 is equal to a distance between the first extending portion 222a of each lower row terminal 22 and the plate portion 32a of the middle grounding plate 3. A lower end of the fifth extending portion 212a horizontally extends backward to form the first soldering portion 214. A projection of a lower end edge of the plate portion 32a in a front-rear direction is higher than a projection of the first soldering portion 214 in the front-rear direction. The multiple grounding pins 33 extend downward from the vertical portion 32, used for being soldered onto a grounding circuit of the circuit board (not shown).

As shown in FIGS. 1, 3 and 4, the outer metal shell 5 includes a top wall 51, a bottom wall 52 and two side walls 53 connecting the top wall 51 and the bottom wall 52. The top wall 51 pierces downward corresponding to the position of the limiting slot 113 to provide an urging portion 511 urging against an inner wall of the limiting slot 113, preventing the outer metal shell 5 from moving forward. In other embodiments, the urging portion 511 may be formed in any other manners, which is not limited herein. A middle portion of each of the side walls 53 extends downward to form a soldering pin 531, a rear end of each of the side walls 53 extends downward to form a soldering pin 531, and the soldering pins 531 are used for being soldered to the circuit board (not shown).

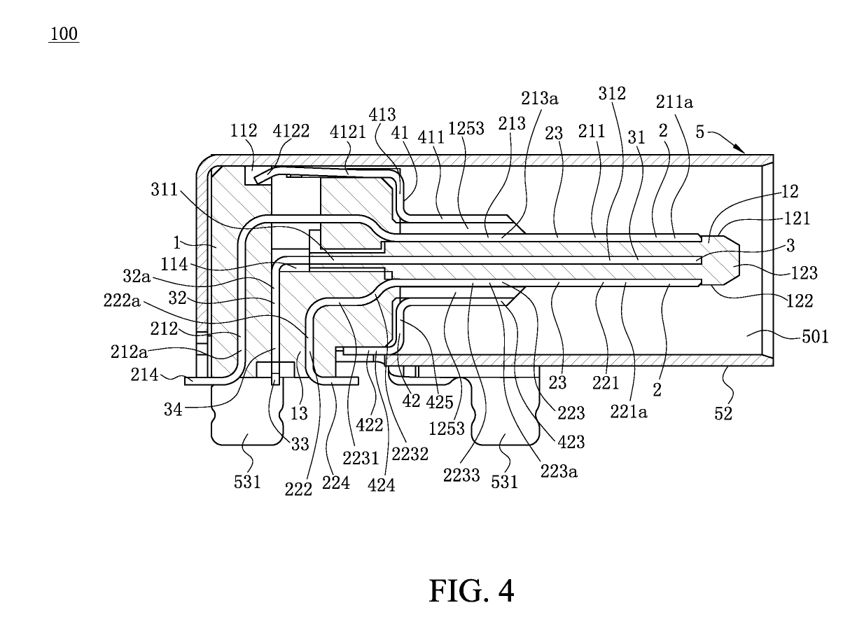

As shown in FIGS. 1 and 4, the inner metal shell 4 includes an upper grounding plate 41 and a lower grounding plate 42. The upper grounding plate 41 includes a covering portion 411, an extending portion 412 and a connection portion 413 vertically connecting the covering portion 411 and the extending portion 412. The covering portion 411 covers the flat plate portion 1253. The extending portion 412 covers an upper surface of the base 11 and is accommodated in the first receiving space 111. Each of two sides of the extending portion 412 has a contacting arm 4121 extending backward and upward. The contacting arms 4121 urges against an inner wall of the outer metal shell 5, to from an electrical connection, making the inner metal shell 4 grounded. The end of each contacting arm 4121 bends downward to form a positioning portion 4122, so that the contacting arm 4121 is in an arc shaped contact with the inner wall of the outer metal shell 5, to facilitate assembling of the outer metal shell 5 to the insulation body 1. The positioning portions 4122 are respectively received in the concave slots 112, preventing the inner metal shell 4 from sliding forward. Each of two side walls of the upper grounding plate 41 is further provided with a mating portion 414. The lower grounding plate 42 includes a first shielding portion 423, a second shielding portion 424 and a third shielding portion 425 connected to the first shielding portion 423 and the second shielding portion 424. The first shielding portion 423 is located on a lower surface of the tongue 12. The second shielding portion 424 is located on a lower surface of the base 11. The first shielding portion 423 and the second shielding portion 424 are both parallel to the body portion 31. The fourth extending portion 2232 of each lower row terminal 22 is gradually away from the second shielding portion 424 from rear to front. The first extending portion 222a is located at a rear side of the second shielding portion 424. A distance between the second extending portion 2231 and the second shielding portion 424 is greater than a distance between the first shielding portion 423 and the third extending portion 2233. Each of two side walls of the lower grounding plate 42 is provided with a fixing portion 421 corresponding to the mating portion 414. The mating portion 414 and the fixing portion 421 are accommodated in the reserving slots 1242 correspondingly in a mutually mating manner, such that the inner metal shell 4 wraps the insulation body 1. The lower grounding plate 42 further has a stopping portion 422. The stopping portion 422 adjoins a lower surface of the plastic block 13, to firmly assemble the plastic block 13 to the base 11. In other embodiments, the upper grounding plate 41 and the lower grounding plate 42 may be integrally formed, which is not limited herein.

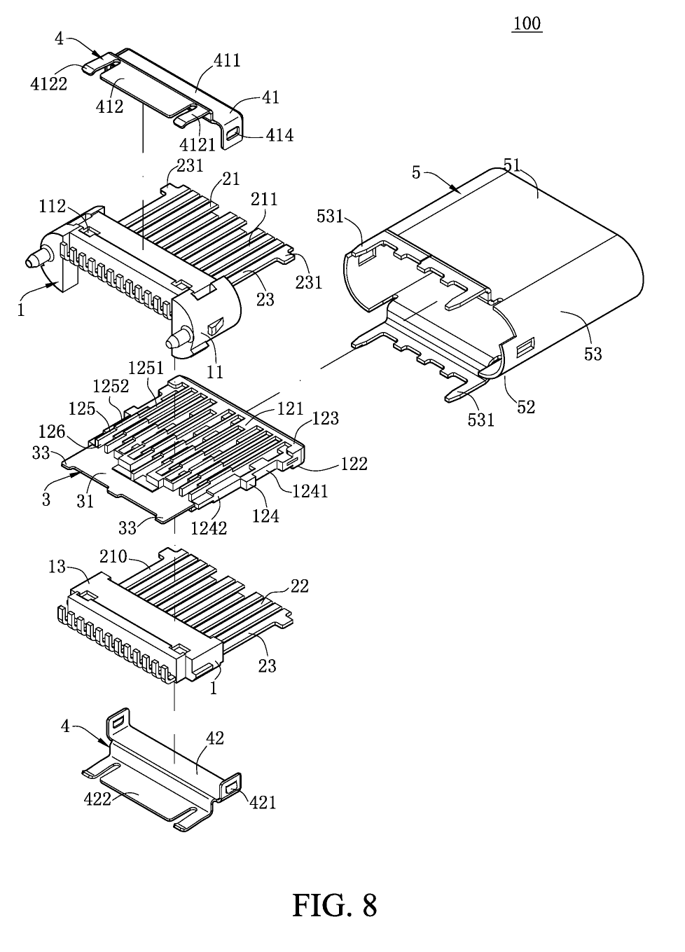

FIG. 8 shows an electrical connector 100 according to a second embodiment of the present invention. The second embodiment is different from the first embodiment in that the electrical connector in the second embodiment is a vertical electrical connector. In this embodiment, the middle grounding plate 3 is not provided with the vertical portion 32, the grounding pin 33 also extends in a direction directly from the body portion 31 to the circuit board (not shown), and the soldering pin 531 extends in a direction from the top wall 51 and the bottom wall 52 to the circuit board (not shown).

As shown in FIGS. 1 and 2, in the electrical connector 100, during assembly, firstly, the base 11 and the upper row terminals 21 are integrally formed, the plastic block 13 and the lower row terminals 21 are integrally formed, and the middle grounding plate 3 is integrally fixed into the tongue 12; secondly, the tongue 12 is inserted into the base 11 from front to rear, and the plastic block 13 is assembled to the base 11 from bottom to top; then, the rear section 1252 is correspondingly hot-melted to retain the terminals 2 onto the tongue 12, the upper grounding plate 41 covers the insulation body 1 downward, and the lower grouping sheet 42 covers the insulation body 1 upward; finally, the outer metal shell 5 is sleeved over the insulation body 1 and correspondingly soldered onto the circuit board (not shown).

As shown in FIGS. 1 and 4, by increasing the distance between the first section 311 of the middle grounding plate 3 and the second extending portion 2231 of each lower row terminal 22, resonance points move backward, thereby improving high-frequency performance of the electrical connector 100. Moreover, the plate portion 32a of the middle grounding plate 3 is soldered onto the grounding circuit of the circuit board through the grounding pins 33. The first rear portions 212 and the second rear portions 222 of the terminals 2 are also soldered onto the circuit board respectively through the first soldering portion 214 and the second soldering portion 224. The distance between the vertical portion 32 of the middle grounding plate 3 and the second rear portion 222 is a fixed value. By increasing the distance between the first section 311 of the middle grounding plate 3 and the second extending portion 2231 of each lower row terminal 22 retained into the base 11, when the lower row terminal 22 is insert-molded with the plastic block 13, the space between the second extending portions 2231 of the lower row terminals 22 and the first section 311 of the middle grounding plate 3 is relatively large, which is conducive to flowing of plastics, such that the plastics can be evenly distributed and filled easily to carry out the process. In other embodiments, the base 11 and the plastic block 13 of the electrical connector 100 may also be integrally formed or formed in any other manners, which is not limited thereto. The second rear portion 222 may extend the second soldering portion 224 to be soldered to the surface of the circuit board. The second soldering portion 224 may also be dipped in the hole of the circuit board. In addition, the distance between the second extending portion 2231 of each lower row terminal 22 and the first section 311 of the middle grounding plate 3 is greater than the distance between the third extending portion 2233 and the second section 312 of the middle grounding plate 3. When the lower row terminals 22 are insert-molded with the tongue 12 or the plastic block 13, the relatively large space between the second extending portion 2231 and the first section 311 of the middle grounding plate 3 for plastic flowing can share the relatively small space between the third extending portion 2233 and the second section 312 of the middle grounding plate 3, such that the plastics can be more evenly and fully distributed in the filling space to better carry out the process. Junctions between the second extending portion 2231 and the first extending portion 222a as well as the fourth extending portion 2232 are arc-shaped bending portions, which allows the plastics to flow and be fully filled at the corners of the space between the terminals 2 and the middle grounding plate 3, thereby improving a retaining effect of the insulation body 1 to the terminals 2.

The fourth extending portion 2232 gradually gets close to the first section 311 from rear to front. The lower row terminals 22 are connected to the third extending portion 2233 and the second extending portion 2231 through the fourth extending portion 2232 which extends in an oblique direction, thereby increasing the distance between the second extending portion 2231 of each terminal 2 and the first section 311 of the middle grounding plate 3. The tongue 12 is relatively narrow, and the base 11 is relatively wide, so that a front end of the fourth extending portion 2232 is disposed at a rear side of a front end face of the base 11. The distance between the front end of the fourth extending portion 2232 and the first section 311 of the middle grounding plate 3 is shorter than the distance between a rear end of the fourth extending portion 2232 of each terminal 2 and the first section 311 of the middle grounding plate 3, so that the distance between the terminals 2 and the middle grounding plate 3 can gradually become larger from the front end to the rear end thereof. The vertical portion 32 of the middle grounding plate 3 is located between the first rear portions 212 of the upper row terminals 21 and the second rear portions 222 of the lower row terminals 22, and the distance between the vertical portion 32 and the first rear portions 212 is equal to the distance between the vertical portion 32 and the second rear portions 222, thereby allowing plastics in the space at two sides of the vertical portion 32 of the middle grounding plate 3 to be evenly distributed in the limited space thereof as much as possible. A length of a projection of the fourth extending portion 2232 in a front-rear direction is shorter than a length of a projection of the first extending portion 222a of each terminal 2 in the front-rear direction, so that the length of the fourth extending portion 2232 is suitable, preventing the fourth extending portion 2232 from being too long and the plastics and the terminal 2 from being distributed improperly. Similarly, a length of a projection of the fourth extending portion 2232 of each terminal 2 is shorter than the length of the second extending portion 2231 of each terminal 2.

In summary, the electrical connector 100 according to certain embodiments of the present invention, among other things, has the following beneficial advantages:

(1) A distance between a second extending portion 2231 of each lower row terminal 22 retained in the base 11 and the first section 311 of the middle grounding plate 3 is greater than a distance between the first extending portion 222a of each terminal 2 and the plate portion 32a of the middle grounding plate 3. The distance between the plate portion 32a of the middle grounding plate 3 and the first extending portion 222a of each terminal 2 is fixed. By increasing the distance between the second extending portion 2231 of each terminal 2 and the first section 311 of the middle grounding plate 3, the resonance points move backward, thereby improving high-frequency performance of the electrical connector 100 and facilitating filling of plastics.

(2) The distance between the second extending portion 2231 of each lower row terminal 22 and the first section 311 of the middle grounding plate 3 is greater than the distance between the third extending portion 2233 of each terminal 2 and the second section 312 of the middle grounding plate 3. The relatively large space between the second extending portion 2231 of each lower row terminal 22 and the first section 311 of the middle grounding plate 3 for plastic flowing can share the relatively small space between the third extending portion 2233 of each lower row terminal 22 and the second section 312 of the middle grounding plate 3, and it is easier to carry out the process.

(3) The fourth extending portion 2232 gradually gets close to the first section 311 of the middle grounding plate 3 from rear to front, thereby gradually increasing the distance between the terminals 2 and the middle grounding plate 3 from front to rear, and the fourth extending portion 2232 is located in the relatively wide base 11 to better carry out the process.

(4) The bending portions connected between the second extending portions 2231 and the first extending portions 222a as well as the fourth extending portions 2232 of the lower row terminals 22 are arc-shaped. When the lower row terminals 22 are insert-molded with the insulation body 1, flowing of plastics is facilitated, such that the plastics can be more fully and evenly filled in the space between the terminals 2 and the middle grounding plate 3 to better carry out the process.

(5) The upper grounding plate 41 has the extending portion 412 covering an upper surface of the base 11, the lower grounding plate 42 has the stopping portion 422 adjoining a lower surface of the plastic block 13, which increases coverage of the inner metal shell 4, can more effectively prevent crosstalk caused by that electromagnetic radiation in the insertion space 501 from leaking backward to interfere tails of the terminals 2 when the electrical connector 100 transmits high-speed signals, and improves signal transmission quality of the electrical connector 100.

(6) The middle grounding plate 3 has the vertical portion 32 located between the first rear portion 212 and the second rear portion 222, which effectively shields telecommunication interference between the first rear portions 212 and the second rear portions 222, and enhances signal transmission stability of the electrical connector 100.

(7) The insulation body 1 is composed of the base 11, the tongue 12 and the plastic block 13, which reduces the difficulty of integrally forming the insulation body 1, improves the manufacturing speed of the insulation body 1, and saves the manufacturing cost of the electrical connector 100.

(8) During assembly, the tongue 12 adopts a hot melting method to retain the terminals 2, which makes the terminals 2 not easy to tilt upward on the tongue 12, and prolongs the service life of the electrical connector 100.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulation body;
a plurality of terminals, arranged in the insulation body in an upper row and a lower row, each of the terminals in the lower row having a first retaining portion, a first extending portion bending downward from a rear side of the first retaining portion, and a first contact portion extending forward from the first retaining portion, wherein the first retaining portion comprises a second extending portion connected to the first extending portion; and
a middle grounding plate, disposed in the insulation body and located between the terminals in the upper low and the lower row, wherein the middle grounding plate has a body portion and a plate portion bending downward from a rear side of the body portion, the body portion has a first section connected to the plate portion and a second section extending forward from the first section, the first section is located above the second extending portion and is parallel to the second extending portion, the plate portion is located at a rear side of the first extending portion and is parallel to the first extending portion, and a distance between the first section and the second extending portion is greater than a distance between the plate portion and the first extending portion.

2. The electrical connector according to claim 1, wherein the plate portion is perpendicular to the body portion.

3. The electrical connector according to claim 1, wherein the insulation body comprises a base and a tongue located at a front end of the base, the first contact portion is exposed from a lower surface of the tongue, the first retaining portion stretches across the base and the tongue, the first extending portion and the first section are respectively located in the base, and the second section is located in the tongue.

4. The electrical connector according to claim 3, wherein the first contact portion is parallel to the second section, and a distance between the first contact portion and the second section is shorter than the distance between the first section and the second extending portion.

5. The electrical connector according to claim 3, wherein the first retaining portion has a third extending portion connected to the first contact portion, and the third extending portion is located in the tongue.

6. The electrical connector according to claim 5, wherein the third extending portion is parallel to the second section, and a distance between the third extending portion and the second section is equal to a distance between the first contact portion and the second section.

7. The electrical connector according to claim 5, wherein the first retaining portion comprises a fourth extending portion connecting to the second extending portion and the third extending portion, and the fourth extending portion is located in the base.

8. The electrical connector according to claim 7, wherein the fourth extending portion is gradually close to the first section from rear to front.

9. The electrical connector according to claim 8, wherein a length of a projection of the fourth extending portion in a front-rear direction is shorter than a length of a projection of the first extending portion in the front-rear direction.

10. The electrical connector according to claim 8, wherein a length of a projection of the fourth extending portion in a vertical direction is shorter than a length of the second extending portion.

11. The electrical connector according to claim 7, wherein the insulation body shields a lower grounding plate, and the lower grounding plate has a first shielding portion located on the lower surface of the tongue, a second shielding portion located on a bottom surface of the base, and a third shielding portion connected to the first shielding portion and the second shielding portion.

12. The electrical connector according to claim 11, wherein the fourth extending portion is gradually away from the second shielding portion from rear to front.

13. The electrical connector according to claim 12, wherein the second shielding portion is parallel to the second extending portion, the first shielding portion is parallel to the third extending portion, and a distance between the second shielding portion and the second extending portion is greater than a distance between the first shielding portion and the third extending portion.

14. The electrical connector according to claim 11, wherein the second shielding portion is located in front of the first extending portion.

15. The electrical connector according to claim 3, wherein each of the terminals in the upper row has a second retaining portion, a second contact portion extending forward from the second retaining portion, and a fifth extending portion bending downward from a rear end of the second retaining portion, the second contact portion is exposed from an upper surface of the tongue, the second retaining portion stretches across the base and the tongue, and the fifth extending portion is located in the base.

16. The electrical connector according to claim 15, wherein the fifth extending portion is located at a rear side of the plate portion and is parallel to the plate portion.

17. The electrical connector according to claim 16, wherein a distance between the fifth extending portion and the plate portion is equal to the distance between the first extending portion and the plate portion.

18. The electrical connector according to claim 15, wherein a lower end of the fifth extending portion horizontally extends backward to form a first soldering portion, and a projection of a lower end edge of the plate portion in a front-rear direction is higher than a projection of the first soldering portion in the front-rear direction.

19. The electrical connector according to claim 3, wherein the first extending portion protrudes downward beyond a bottom surface of the base, and the first extending portion connects to a second soldering portion.

20. The electrical connector according to claim 3, wherein the first extending portion and the second extending portion are connected through an arc-shaped bending portion.
